(19) United States
(12) Patent Application Publication
(10) Pub. No.: US 2026/0138077 A1
(43) Pub. Date: May 21, 2026

(54) BLUE CARBON PROCESS AND SYSTEM FOR DIRECT AIR CARBON CAPTURE AND STORAGE

(71) Applicant: Sigan PENG, Shanghai (CN)

(72) Inventors: Sigan PENG, Shanghai (CN); Yingchuan PENG, Shanghai (CN)

(21) Appl. No.: 19/114,511

(22) PCT Filed: Sep. 25, 2023
(86) PCT No.: PCT/CN2023/120951

§ 371 Date: Mar. 24, 2025

(30) Foreign Application Priority Data
Sep. 26, 2022 (WO) PCT/CN2022/121167
Dec. 28, 2022 (WO) PCT/CN2022/142813
Feb. 15, 2023 (WO) PCT/CN2023/076157
Aug. 19, 2023 (WO) PCT/CN2023/113913

(51) Int. Cl. B01D 53/14; B01D 53/18

(52) U.S. Cl. CPC B01D 53/1475; B01D 53/18; B01D 2221/16; B01D 2252/1035; B01D 2257/504; B01D 2258/06

(57) ABSTRACT

The present invention relates to a blue carbon process and a blue carbon process system for direct air carbon capture and storage. The natural energy such as wind energy, solar energy and wave energy is used. Only natural seawater (without artificial chemicals) is used to directly capture and store carbon dioxide from air. Amount of the carbon dioxide is measured and calculated. To achieve the climate goal of “net zero” carbon emission, a low-cost and large-scale net negative emission solution with zero carbon footprint, zero artificial chemical footprint and zero land footprint is provided.

### FIELD OF THE INVENTION

The present invention provides a blue carbon process and a blue carbon system for direct air carbon capture and storage, which are used to directly capture and store CO₂ from the air, so as to realize the climate goal of zero carbon emission before the middle of this century. The present invention belongs to the technical fields of negative carbon emission of climate change mitigation and marine engineering.

### DESCRIPTION OF RELATED ART

In the past 30 years of climate change mitigation technology, carbon capture and storage (CCS) for CO₂ of fossil fuel flue gas has been regarded as the key for climate change mitigation, but it cannot function well because there is always a cost-scale challenge. In the past 10 years, the technology of direct air carbon capture and storage (DACCS), also known as negative emission technology (NET), has been unprecedentedly expected to be the key and core technology, or even the ultimate technical means, to achieve climate goals.

However, the cost-scale challenge of the existing DACCS technology is far more serious than that of CCS. For example, a typical scheme is the chemical direct air carbon capture (DAC) process, wherein the materials and energy consumption include: air contactor energy consumption, strong alkali chemicals for absorption, sub strong alkali chemicals for replacement, regeneration system for two sets of chemicals, oxygen plant of high power consumption for the regeneration system, and thermal power plant specially built for providing heat and power for the entire DAC system. For this reason, it is estimated that it will consume more than half of the world's existing power to run this kind of DAC process fully.

The research report “Direct Air Capture of CO₂ with Chemicals 2011” by the American Physical Society (APS) suggests that existing chemical DAC technology routes are not economically feasible for climate change mitigation, and the improved technology routes based on chemical DAC technology also cannot reduce DAC costs to a feasible and usable level unless a fundamental new technology route is presented.

On the other hand, the United Nations Framework Convention on Climate Change (UNFCCC) has always called for attention to the utilization of the Earth's natural carbon sink, which is mainly composed of marine ecosystem carbon sinks (over 93%). The “Carbon Capture and Storage (CCS) Special Report” in 2005 by the United Nations Intergovernmental Panel on Climate Change (IPCC) also pointed out that 40% of the CO₂, which has been emitted by humans into the atmosphere over the past 200 years from Industrial Revolution, was naturally absorbed by the ocean from the atmosphere. Effective use of the carbon sink of marine ecosystems will be a cost-effective solution for climate change mitigation. People are starting to pay attention to the utilization of carbon sinks in marine ecosystems, both biotic and abiotic factors in the ocean. Especially since the signing of the Paris Agreement and the proposal of achieving the climate goal of “net zero carbon emission” by the middle of this century, people's expectations for ocean-based greenhouse gas removal (GGR), including “negative emissions technology” (NET), have been increasing. In recent years, there is even a call that “ocean-based GGR is the real hope for climate goal of net zero carbon emission”. However, the ability of the ocean to naturally absorb CO₂ from the atmosphere is limited by the chemical equilibrium at the ocean/atmosphere interface and will not naturally increase. The absorption scale will not naturally increase and cannot automatically replace the urgently needed DACCS technology for climate change mitigation. Therefore, how to overcome the chemical balance limitations of the air-ocean interface to incrementally utilize the natural carbon sinks in the ocean emerges as an avehue for ocean-based GGR/NET technology. There are mainly two types of schemes including artificial carbon sink substitution and natural carbon sink development. The first one proposes to use artificial chemicals (including electrochemical chemicals) to change the chemical balance of the air-ocean interface, which is essentially a solution of replacing natural carbon sinks with artificial carbon sinks, thus it cannot fundamentally change the difficult situation caused by factors such as unaffordable costs, unclear legal status, and uncertain impact on the marine ecological environment. The second one proposes to use marine biological factors such as seaweed and ocean fertilization, as well as atypical marine biological factors such as mangroves (intertidal plants) and other ocean-based natural carbon sinks, but there is still a feasibility problem for climate change mitigation. Firstly, the overall applicable scale of these marine biological carbon sinks is significantly less than the scale required for climate change mitigation. Secondly, these marine biological carbon sinks belong to non independent carbon sinks. It is well known that both biotic and abiotic factors in marine ecosystems are submerged in the marine water without direct contact with the atmosphere. As effective carbon sinks for the atmosphere, they must depend on marine water. Therefore, existing technical solutions, which only utilize several marine biotic carbon sinks, are not effective for direct air carbon capture and storage. It also shows that the popular concept of blue carbon in the past decade, if limited to a few of marine biotic carbon sinks, will lose its significance for climate change mitigation.

The U.S. Pat. No. 11,045,785B2 proposed in 2016 discloses a DACCS scheme based on the utilization of natural ocean carbon sinks. In the process, only natural seawater is used, without any artificial chemicals. However, it does not disclose technical solutions such as large-scale running steps and steps of joining the carbon accounting framework.

### SUMMARY OF THE INVENTION

The first purpose of the present invention is to overcome the deficiency of unaffordable cost in existing technical solutions of chemical DACCS and to provide an economically feasible solution of direct air carbon capture and storage (DACCS).

The second purpose of the present invention is to overcome the deficiency of applicable scale in existing NET technical solutions and to provide a DACCS solution that utilizes marine ecosystem carbon sinks, including both biotic and abiotic factors, as a whole.

The third purpose of the present invention is to overcome the deficiency in existing DACCS technical solutions based on the utilization of marine natural carbon sinks, and to provide a DACCS solution that can be carried out on a large scale and join the carbon accounting framework.

The overall purpose of the present invention is to provide a low-cost and large-scale net negative emission solution with zero carbon footprint, zero chemical footprint, and zero land footprint to achieve the climate goal of net zero carbon emission.

The blue carbon process for direct air carbon capture and storage of the present invention comprises the steps of:
1) providing an absorber;
2) pumping seawater from an ocean below sea level to a height above sea level to generate absorbing seawater, and introducing the absorbing seawater and air into the absorber;
3) allowing the absorbing seawater to absorb and capture the carbon dioxide from the air in the absorber to generate after-absorbing seawater; and
4) discharging the after-absorbing seawater out of the absorber and into the ocean below sea level through a water discharging pipe to realize ocean carbon storage;
wherein, the absorber comprises a shading cover for blocking out sunlight, so that the contact between the absorbing seawater and the air is performed under shading condition, to prevent or reduce growth of marine organisms inside the absorber.

The further preferred embodiments are provided as below.

In the absorber, the absorbing seawater flows from top to bottom due to gravity, and the air flows from top to bottom, or flows from bottom to top, or flows laterally to make contact with the absorbing seawater.

The process further comprises a step of providing a blowing device for introducing the air into the absorber.

The shading cover is located at the top of the absorber, and the blowing device is located under the shading cover, and the blowing device is configured to drive the air to flow from top to bottom or flow from bottom to top.

In the absorber, the air flows laterally, and the shading cover is a louvered shading cover.

The process further comprises the steps of: measuring the amount of carbon dioxide (CO₂e), which is absorbed and captured by the absorbing seawater from the air and is then converted to bicarbonate ions (HCO₃⁻) and discharged into the ocean below sea level with the absorbing seawater, to generate measurement data; and transmitting the measurement data in real-time or periodically to a carbon accounting system.

The porcess further comprises a step of measuring the amount of carbon dioxide in the absorbing seawater and the amount of carbon dioxide in the after-absorbing seawater, thereby achieving the data of amount of the carbon dioxide (CO₂e), which is absorbed, captured and stored by the absorbing seawater.

In the step of measuring the amount of carbon dioxide in the absorbing seawater and the amount of carbon dioxide in the after-absorbing seawater, ion selective electrode detection or carbon-13 isotope detection is used to measure the content of bicarbonate ions (HCO₃⁻) and/or dissolved inorganic carbon (DIC).

The process further comprises a step of measuring the amount of carbon dioxide, which is contained in the air before contact with the absorbing seawater, and the amount of carbon dioxide, which is contained in the air after contact with the absorbing seawater, thereby achieving the data of the amount of carbon dioxide, which is absorbed by the absorbing seawater.

The absorber further includes packings for increasing the contact area between the absorbing seawater and the air.

The absorbing seawater is pumped from the ocean below sea level to a height no more than 0.5 m, or 1 m, or 3 m, or 5 m, or 10 m, or 15 m, or 20 m, or 30 m, or 50 m above sea level to obtain potential energy, and the height is defined by the distance between an outlet of the absorbing seawater in the absorber and the sea level where the absorbing seawater is drawn.

The absorber is located on a floating ocean platform.

The process further comprises as step of providing a water drawing pipe for drawing seawater, wherein the water drawing pipe and/or water discharging pipe are configured to be extendable to facilitate the movement of the floating ocean platform.

The process further comprises a step of providing a carbon-free energy apparatus for providing energy.

The process further comprises a step of providing an energy storing device for storing the energy generated by the carbon-free energy apparatus, and providing energy when the carbon-free energy system is unable to provide energy.

The process further comprises a step of capturing one ton of carbon dioxide from the air with an energy consumption no more than 10 GJ/t, or 5 MJ/t, or 1 GJ/t, or 500 MJ/t, or 300 MJ/t, or 100 MJ/t, or 30 MJ/t, or 20 MJ/t, or 10 MJ/t, or 5 MJ/t.

The process further compises the steps of: providing a plurality of absorbers; and collecting the after-absorbing seawater generated by the absorbers and discharging it into the ocean through the water discharging pipe.

The seawater is drawn from the ocean at a depth of at least 0.5 m, or at least 1 m, or at least 3 m, or at least 5 m, or at least 10 m, or at least 15 m, or at least 20 m, or at least 30 m, or at least 50 m, or at least 80 m, or at least 100 m, or at least 150 m, or at least 200 m, or at least 250 m, or at least 300 m, or at least 500 m, or at least 800 m, or at least 1000 m, or at least 2000 m below sea level.

In the course of discharging the after-absorbing seawater out of the absorber in step 4), the after-absorbing seawater is discharged into the ocean below sea level through a water discharging pipe by its own weight, and the outlet of the water discharging pipe is located below sea level, or the outlet of the water discharging pipe is located in the ocean at a depth of at least 0.5 m, or at least 3 m, or at least 5 m, or at least 10 m, or at least 15 m, or at least 20 m, or at least 30 m, or at least 50 m, or at least 80 m, or at least 100 m, or at least 150 m, or at least 200 m, or at least 250 m, or at least 300 m, or at least 500 m, or at least 800 m, or at least 1000 m, or at least 2000 m below sea level.

The steps 1), 2), 3) and 4) are carried out continuously throughout the year.

The system for direct air carbon capture and storage (DACCS) of the present invention includes:
a seawater pump and a water drawing pipe for pumping seawater from the ocean below sea level to a height above sea level to generate absorbing seawater;
an absorber (DAC Absorber) for introducing air and the absorbing seawater, so that the absorbing seawater absorbs the carbon dioxide in the air to generate after-absorbing seawater;
a water discharging pipe for discharging the after-absorbing seawater into the ocean below sea level;
wherein, the absorber includes a shading cover for blocking out sunlight, so that the contact between the absorbing seawater and the air is performed under shading condition, to prevent or reduce the growth of marine organisms inside the absorber.

The further preferred embodiments are provided as below.

The absorber is configured so that the absorbing seawater flows from top to bottom due to gravity, and the air flows from top to bottom, or flows from bottom to top, or flows laterally to make contact with the absorbing seawater.

The system further comprises a blowing device for introducing the air into the absorber.

The shading cover is located at the top of the absorber, and the blowing device is located under the shading cover, and the blowing device is configured to drive the air to flow from top to bottom or flow from bottom to top.

In the absorber, the air flows laterally, and the shading cover is a louvered shading cover.

The system further includes a CO₂e measuring apparatus for measuring the amount of carbon dioxide (CO₂e), which is absorbed and captured by the absorbing seawater from the air and is then converted to bicarbonate ions (HCO₃⁻) and discharged into the ocean below sea level with the absorbing seawater, to generate measurement data and transmitting the measurement data in real-time or periodically to a carbon accounting system.

The CO₂e measuring apparatus comprises a device for measuring the amount of carbon dioxide in the absorbing seawater and a device for measuring the amount of carbon dioxide in the after-absorbing seawater.

The device for measuring the amount of carbon dioxide in the absorbing seawater and the device for measuring the amount of carbon dioxide in the after-absorbing seawater are configured to use ion selective electrode detection or carbon-13 isotope detection to measure the content of bicarbonate ions (HCO₃⁻) and/or dissolved inorganic carbon (DIC).

The device for measuring the amount of carbon dioxide in the absorbing seawater and the device for measuring the amount of carbon dioxide in the after-absorbing seawater include an ion selective electrode or a carbon-13 isotope detector.

The CO₂e measuring apparatus includes a device for measuring the amount of carbon dioxide, which is contained in the air before contact with absorbing seawater, and a device for measuring the amount of carbon dioxide, which is contained in the air after contact with the absorbing seawater.

The absorber further includes packings for increasing the contact area between the absorbing seawater and the air.

The packings are made of materials resistant to marine climate, and the materials resistant to marine climate are selected from one or more of metals, ceramics and polymer materials.

The absorber include a water distributor, and the height of an outlet of the distributor is no more than 0.5 m, or 1 m, or 3 m, or 5 m, or 10 m, or 15 m, or 20 m, or 30 m, or 50 m relative to the sea level where the absorbing seawater is drawn.

The system further comprises a floating ocean platform, and the absorber is located on the floating ocean platform.

The water drawing pipe and/or the water discharging pipe are configured to be extendable to facilitate the movement of the floating ocean platform.

The system further includes a carbon-free energy apparatus for providing the energy.

The carbon-free energy apparatus and the absorber are located on the same ocean platform.

The ocean platform is a fixed ocean platform or a floating ocean platform.

The carbon-free energy apparatus is located on a second ocean platform or on land.

The system includes a plurality of absorbers, and the after-absorbing generated by the absorbers is collected and discharged into the ocean through the water discharging pipe.

The inlet of the water drawing pipe is located in ocean at a depth no less than 0.5 m, or 1 m, or 3 m, or 5 m, or 10 m, or 15 m, or 20 m, or 30 m, or 50 m, or 100 m, or 200 m, or 300 m, or 500 m, or 1000 m, or 2000 m below sea level.

The outlet of the water discharing pipe is located in ocean at a depth no less than 0.5 m, or 1 m, or 3 m, or 5 m, or 10 m, or 15 m, or 20 m, or 30 m, or 50 m, or 100 m, or 200 m, or 300 m, or 500 m below sea level.

The system further includes an energy delivering apparatus for delivering the energy produced by a carbon-free energy apparatus to an apparatus out of the system.

The technical principle and effects of the present invention are described as follows.

On the one hand, the inventor of the present invention found that because the surface of the ocean is highly likely to be exposed to sunlight and rain, the surface seawater is often warmer thus it is lighter, and the salinity of the surface seawater is often lower thus the surface seawater is lighter. Therefore, there are always two marine hydrology phenomenons including “temperature difference layering” and “salinity difference layering”, which significantly reduces the exchange between the upper and lower parts of the ocean water body, resulting in a chemical equilibrium state of lower CO₂ absorption level at the ocean/atmosphere interface. Therefore, in the present invention, seawater with lower temperature and higher salinity below sea level is pumped and introduced into an absorber above sea surface, in which the seawater fully contacts with the air to break the chemical equilibrium at the interface between the ocean and the atmosphere, allowing more CO₂ in the air to be dissolved in absorbing seawater, and is then discharged and stored in the ocean.

According to the chemical reaction formula for CO₂ dissolution in seawater: CO₂+H₂O+CO₃²⁻→2HCO₃⁻, CO₂ is dissolved in seawater and permanently stored in the ocean as bicarbonate ions (HCO₃⁻)-, which is the natural form of carbon element.

On the other hand, the inventor of the present invention also found that the factor, which determines the effeciency of absorbing and capturing CO₂ of extremely low concentrations (about 400 ppm) from the air, is not the alkalinity of the absorbent, but the affinity of the absorbent for CO₂, i.e. surface activity. In this regard, natural seawater is better than artificial chemical agents. Therefore, in the present invention, only natural seawater is used for contact with the air passing through the absorber, and the process is running under conditions of blocking out sunlight to prevent the growth of marine organisms from damaging the advantage of seawater affinity. In addition, the carbon dioxide equivalent (CO₂e), which is directly captured and stored from the air can be caculated. The DACCS scheme can be carried out in various marine areas including nearshore or offshore areas in a large scale for long term.

The present invention has the following effects on direct air carbon capture and storage. Firstly, the economic feasibility problem of climate change mitigation is solved. The energy consumption cost of the solution in the present invention is at least 2 orders of magnitude lower than one of the technical solution of artificial chemical DAC. Secondly, the problem of available carbon sink scale is solved. In the solution of present invention, the entire carbon sink of marine ecosystems, including both biotic and abiotic factors, is utilized, which is helpful to overcome the dilemma of carbon sink shortage on global greenhouse gas emissions reduction. Thirdly, the problem of large-scale practical running is solved, which provide a scalable and calculable solution for the actual running of net negative emissions to achieve the climate goal of “net zero” carbon emission.

The present invention has another effect as follows. The concept of blue carbon is enlarged to include the utilization of all carbon sinks including marine biotic and abiotic factors, which helps the United Nations Framework Convention on Climate Change (UNFCCC) to fulfill its commitment to value and promote the utilization of carbon sinks in marine ecosystems.

### BRIEF DESCRIPTION OF THE DRAWINGS

FIG. 1 is a schematic diagram showing an example of the blue carbon process for direct air carbon capture and storage of the present invention.

FIG. 2 is a schematic diagram showing an example of the net negative emission system especially used in the process of the present invention.

FIG. 3 is a schematic diagram showing an example of the technical steps of the net negative emission system especially used in the process of the present invention.

FIG. 4 is a schematic diagram showing another example of the net negative emission system especially used in the process of the present invention.

FIG. 5 is a schematic diagram showing an example of the technical steps of the net negative emission system especially used in the process of the present invention.

FIG. 6 is a schematic diagram showing an example of net negative emission power plant in the process of the present invention, which is characterized that a wind power plant and a net negative emission ocean platform are provided cooperatively to generate electricity with net negative carbon emission and deliver it to the outside.

FIG. 7 is a schematic diagram showing an example of the technical steps of the net negative emission power plant in the process of the present invention.

FIG. 8 is a schematic diagram showing an example of the net negative emission system of ocean waves and current energy, which especially used in the process of the present invention.

Names of components or structures corresponding to the reference numbers in the drawings are provided as follows.

1—carbon-free energy apparatus, 1.1—wind power plant, 1.2—wind turbine, 1.3—energy storing apparatus, 1.4—power line, 1.5—photovoltaic power plant, 1.6—apparatus for using ocean current energy to generate power and storing energy, 1.7—ocean current turbine, 1.8—energy delivering apparatus, 2-DACCS system, 2.1—absorber, 2.2—water distributor, 2.3—packing layer, 2.4—liquid collecting pool, 2.5—water inlet pipe of absorber, 2.6—water inlet of absorber, 2.7—water outlet of absorber, 2.8—shading cover of absorber, 2.8′-louvered ventilated shading cover, 2.9—air/wind, 2.10—seawater pump, 2.11—water drawing pipe, 2.12—water discharging pipe, 2.13—axial blowing fan, 2.14—blowing motor, 2.15—air inlet of absorber, 2.16—air outlet of absorber, 2.17—water collecting tank, 2.18—outlet height of aborbing seawater in absorber, 3—CO₂e meter, 3.1—channel for transmitting CO₂e data to carbon accounting system, 3.2—measuring and sampling data channel, 4—floating ocean platform, 4A—active ocean platform, 4B—passive ocean platform, 4.1—supporting frame of absorbing column, 4.2—power system for moving floating platform (energy storing apparatus, controller, propeller, anchor, etc.).

### DETAILED DESCRIPTION OF THE PREFERRED EMBODIMENTS

### Example 1

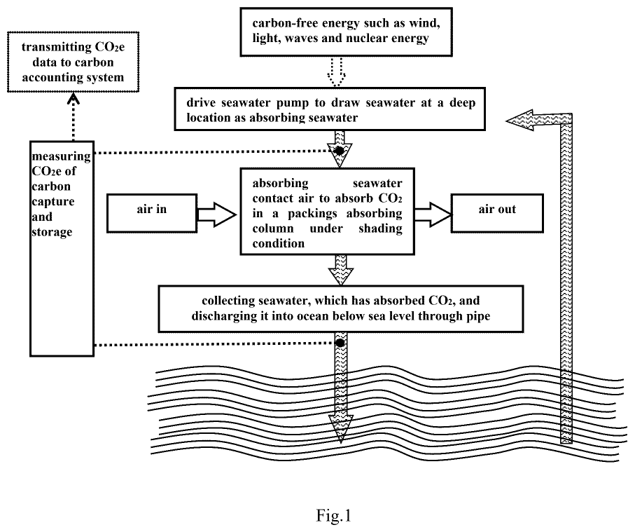

This is a basic example of blue carbon process for direct air carbon capture and storage of the present invention. As shown in FIG. 1, the process comprises the steps as follows.
1) Carbon-free energy is used to drive a seawater pump to pump seawater from a deeper level below sea surface to a height above sea surface, which is used as absorbing seawater with gravitational potential energy. The absorbing seawater and the air are introduced into the same absorber (DAC Absorber) separately.
2) The absorbing seawater is introduced into the DAC Absorber from the outside, and is dispersed through a water distributor inside the absorbing column, and flows downwards along the cross-section of the absorbing column by its own weight to make contact with the air, so that the air absorbs and captures CO₂ in the air. A packing layer is provided in the absorber to increase the contact area between the absorbing seawater and the air, thereby improving the capture efficiency of absorbing carbon.
3) After the absorbing seawater absorbs and captures CO₂ in the air, it is collected to a water collection pool at a lower part of the absorber and is discharged into ocean at a deeper location below sea level through a water discharging pipe by its own weight, so that the CO₂, which is absorbed and captured by the absorbing seawater from air, is converted into incremental bicarbonate ions (HCO₃⁻) for ocean carbon storage. After CO₂ is absorbed, the air is discharged from the absorbing column and returned to the atmosphere.
4) The incremental amount of carbon dioxide (CO₂e), which has been absorbed and captured from the air and converted into bicarbonate ions (HCO₃⁻) and stored in the ocean, is measured and caculated.
5) In the absorber, the entire process, from the step 1) of introducing absorbing seawater and air to the step 3) of discharging the absorbing seawater and air, is carried out under condition of blocking out sunlight to prevent photosynthesis to prevent the growth and aggregation of marine organisms in the absorber.

This example can be carried out as DACCS scheme on a large scale and for a long time in various marine areas, including nearshore or offshore areas.

### Example 2

This is a group of examples based on Example 1. As shown in FIGS. 1, 3, 5, 7 and 8, in the step of measuring and caculating the amount of CO₂e which is captured directly from air and stored in ocean, process and device for comparing the difference of bicarbonate ion (HCO₃⁻) content and/or dissolved inorganic carbon (DIC) content between the absorbing seawater, which is introduced into the absorber, and the after-absorbing seawater, which is collected to the water collection pool 2.4 located at the lower part of the absorber and discharged through the water discharging pipe, are used. The comparing results, which serve as the accounting basis for the CO₂e of direct air capture and storage, are transmitted to the designated carbon accounting system, and are checked and verified by the carbon accounting system. In the step of comparing the difference of bicarbonate ion (HCO₃⁻) content and/or dissolved inorganic carbon (DIC) content, ion selective electrode detection method and instrument are used in one example, and carbon-13 isotope detection method and instrument are used in another example. In another example, the DAC CO₂e meter 3 includes a comparing device for camparing the difference of bicarbonate ion (HCO₃⁻) content and/or dissolved inorganic carbon (DIC) content between the absorbing seawater, which is introduced into the absorber 2.1, and the after-absorbing seawater, which is collected to the lower part and discharged through the water discharging pipe. The comparing device includes an ion selective electrode and a carbon-13 isotope detector, and also includes a transmitting device for transmitting the comparing results and calculating data to a designated carbon accounting system. In another example, in the step of measuring the amount of CO₂e which is directly captured from air and stored in the ocean, the process and advice for measuring the difference of CO₂ content between the air, which is introduced into the absorber, and the air, which is discharged from the absorber, are used.

### Example 3

This is a group of examples based on Example 1. As shown in FIGS. 3, 5, 7 and 8, the absorber 2.1 is installed on a floating ocean platform 4. Relative to sea level where the absorbing seawater is drawn, the height of the outlet of the absorbing seawater in the water distributor 2.2 of the absorber, which is also the height of the potential energy of the absorbing seawater pumped into the absorber, namely, the outlet height of absorbing seawater in absorber 2.18, is not higher than 0.5 m, or 1 m, or 3 m, or 5 m, or 10 m, or 15 m, or 20 m, or 30 m, or 50 m, to ensure large-scale carbon capture. When the power for drawing and pumping the absorbing seawater is constant, the amount of absorbing seawater is positively correlated with the amount of carbon capture, and negatively correlated with the actual pumping height of the absorbing seawater.

### Example 4

This is a group of examples based on Example 1. A water distributor 2.2 is provided in the absorber 2.1. The water distributor 2.2 evenly disperses the absorbing seawater along the cross-section of the absorbing column and sprays it downwards. The contact direction between the air and the absorbing seawater, which is sprayed downwards, can be co-current, counter-current, or cross-current.

### Example 5

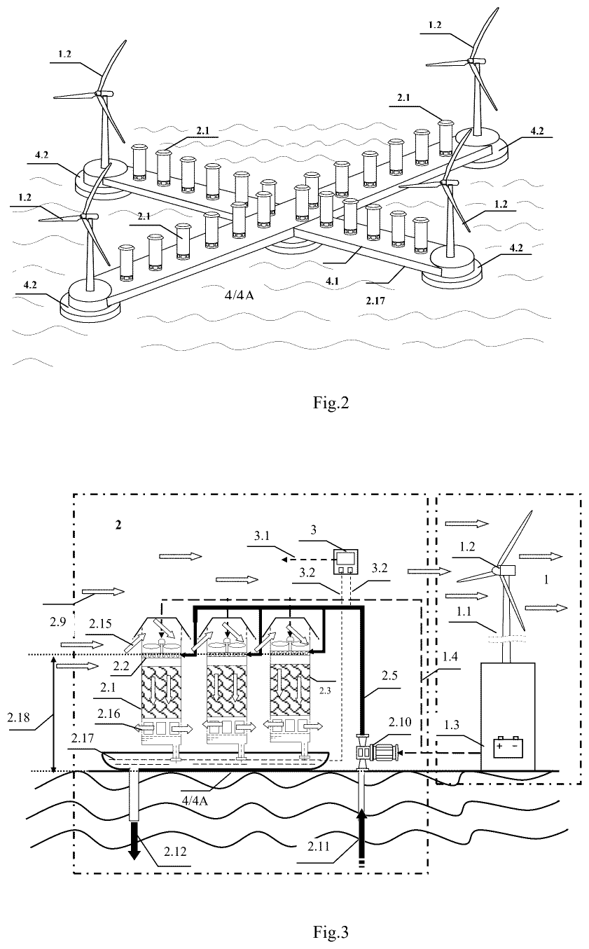

This is a group of examples based on Example 1. As shown in FIGS. 2 to 8, in the step of introducing the air into the carbon absorbing column, the active blowing method is used, wherein a carbon-free energy is usded to drive a blowing device to introduce the air into the carbon absorbing column, or the natural air intake method is used, wherein the natural air blows through the carbon absorbing column. A louvered ventilated shading cover 2.8 is provided out of the absorbing column for natural air intake.

### Example 6

This is a group of examples based on Example 1. As shown in FIGS. 1 to 8, the carbon-free energy apparatus 1 uses one of the wind energy, solar energy, wave energy, tidal energy, nuclear energy and other carbon free energy sources. In another example, the carbon-free energy apparatus 1 is equipped with an energy storing device 1.3 to achieve uninterrupted power supply. In the step of using carbon-free energy to drive the seawater pump in another group of examples, the natural energy is converted into mechanical energy and/or electrical energy to drive the seawater pump.

### Example 7

This is a group of examples based on Example 1. As shown in FIGS. 1 to 8, in the step of drawing seawater from a deep location below sea surface, the lower inlet of the water drawing pipe 2.11 is located at a depth not less than 0.5 m, or 1 m, or 3 m, or 5 m, or 10 m, or 15 m, or 20 m, or 30 m, or 50 m, or 100 m, or 200 m, or 300 m, or 500 m, or 1000 m, or 2000 m below sea level.

### Example 8

This is a group of examples based on Example 1. As shown in FIGS. 1 to 8, in the step that the seawater is discharged through the water discharging pipe by its own weight into the ocean at a deep location below sea lever, the outlet of the water discharging pipe 2.12 is located at a depth no less than 0.5 m, or 1 m, or 3 m, or 5 m, or 10 m, or 15 m, or 20 m, or 30 m, or 50 m, or 100 m, or 200 m, or 300 m, or 500 m below sea level.

### Example 9

This is a group of examples based on Example 1. As shown in FIGS. 1 to 8, the J/t ratio of the energy consumption, which is used for driving the seawater pump with carbon-free energy and blowing air (J), to per ton of carbon dioxide (t-CO₂), which is directly captured and stored from air, does not exceed 10 GJ/t, or 5 GJ/t, or 1 GJ/t, or 500 MJ/t, or 300 MJ/t, or 100 MJ/t, or 30 MJ/t, or 20 MJ/t, or 10 MJ/t, or 5 MJ/t.

### Example 10

This is an example of a device for direct air carbon capture and storage (DACCS) used in the process of the present invention. The device includes an absorber 2.1 for absorbing CO₂ from the air, and a water inlet pipe of absorber 2.5, a seawater pump 2.10, a water drawing pipe 2.11, a water discharging pipe 2.12, a CO₂e meter 3 for measuring and caculating the amount of DAC carbon capture and storage, and a floating ocean platform 4. An absorber 2.1 or an array composed of a plurality of absorbers 2.1 is installed on the floating ocean platform 4. A water distributor 2.2 is provided in the absorber 2.1, spraying the absorbing seawater along the cross-section of the absorbing column so that the absorbing seawater falls downwards. A packing layer 2.3 is also provided in the absorber 2.1, increasing the contact area between water and gas. A shading cover 2.8 is provided out of the absorber 2.1, blocking out sunlight to prevent the growth of marine organisms. The seawater pump 2.10 pumps seawater from the ocean below the sea surface as absorbing seawater. The seawater is pumped through the water inlet pipe of absorber 2.5 to the water inlet 2.6 and introduced into the water distributor 2.2 in the absorber 2.1, then is sprayed along the cross-section of the absorbing column and falls down through the packing layer, and make contact with the air, which blows directly and/or is blowed by blowing device (the axial blowing fan 2.13 and blowing motor 2.14) into the absorber 2.1 through the packing layer 2.3, to perform carbon capture of seawater absorption. The after-absorbing decarbonized air is discharged from the absorbing column 2.1 and returned to the atmosphere. The after-absorbing seawater, which flows through the packing layer to absorb CO₂ from the air and contains incremental bicarbonate ions (HCO₃⁻), is collected at the lower part of the absorbing column 2.1, and flows out through the water outlet of absorber 2.7. Then it is discharged into the ocean below sea level through the water discharging pipe 2.12, or it first flows through the water collecting tank 2.17 and is then discharged into the ocean below sea level through the water discharging pipe 2.12. The DAC CO₂e meter 3 is used to measure the amount of direct air carbon capture and storage to produce the data. The driving energy needed for the seawater pump 2.10 and/or the blowing device (axial blowing fan 2.13 and blowing motor 2.14) is provided by a carbon-free energy apparatus 1 with zero carbon footprint to achieve net negative emission throughout the entire process.

### Example 11

This is a group of examples based on Example 10. The carbon-free energy apparatus 1 and the absorber 2.1 are installed on the same floating ocean platform 4, composing an active ocean platform 4A. The active DACS ocean platform 4A can be fixed and mobile. The carbon-free energy apparatus 1 on the active ocean platform 4A includes an energy storing device 1.3. The active ocean platform 4A includes a power system for moving floating platform 4.2, which includes an energy storing device, a controller, a propeller, an anchor, etc. The power system for moving floating platform 4.2 has the propulsion power and control capability of ocean movement, and/or capability for adjusting the attitude of the platform, to enable the floating ocean platform 4 to be fixed at or moved to a designated sea area. The designated sea area can be a sea area with high DACCS ability due to significant temperature differences of shallow layer, a sea area where it is required to avoid human activities or marine biological activities, and a sea area that are required by active ocean platform itself. In one example, all the active ocean platforms compose a DACCS fleet.

### Example 12

This is a group of examples based on Example 10. The carbon-free energy apparatus 1 is installed separately on a place near the passive ocean platform 4B where the absorber 2.1 is installed, including adjacent offshore and/or onshore areas. The carbon-free energy apparatus 1 provides power for the passive ocean platform 4B. The carbon-free energy apparatus 1 includes a natural energy power plant, such as wind power plant and photovoltaic power plant, and a nuclear power generation device.

### Example 13

This is an example based on Example 10. The packings of packing layer 2.3 are made of materials that are resistant to marine climate, including metals, ceramics, polymer materials, etc.

### Example 14

This is an example of energy production system of net negative carbon emission based on Examples 1 and 10, which is used in the process and device of the present invention. The carbon-free energy apparatus 1 includes facilities for producing carbon-free energy such as wind energy, solar energy, wave tidal energy, nuclear energy, etc. If needed, it also provides electricity and/or thermal energy, and/or hydrogen production and other energy products of zero carbon footprint to energy loads outside of the DACCS through an energy delivering apparatus 1.8.

### Example 15

This is a group of examples based on Example 1.

FIG. 2 shows an example of a net negative emission system specially used in the process of the present invention, characterized in that a horizontal axis wind turbine is installed on a special ocean platform, which is used as the carbon-free energy system, and an array, which is composed of a plurality of DAC (Direct Air Carbon Capture) absorbing columns, forms a special net negative emission ocean platform.

FIG. 3 shows an example of the technical steps of the net negative emission system specially used in the process of the present invention, characterized in that the electric power generated by the wind turbine is used to drive the blowing fan, which is located over the absorber, to blow air axially, causing air to flow from top to bottom, or flow from bottom to top through the packing layer along the absorber axis. A shading cover is provided over and around the absorbing column. The wind turbine is also used to drive the seawater pump to pump seawater from a deep location. The seawater is introduced into the absorber, and flows through the packing layer to scrub the air to absorb CO₂. The special net negative emission system is equipped with a measuring and caculating system that can calculate CO₂e based on the difference of dissolved inorganic carbon (DIC) content between the scrubbing seawater flowing in and the scrubbing seawater flowing out, and the flow rate. The wind turbine is equipped with an energy storing device so that the net negative emission system can run uninterruptedly.

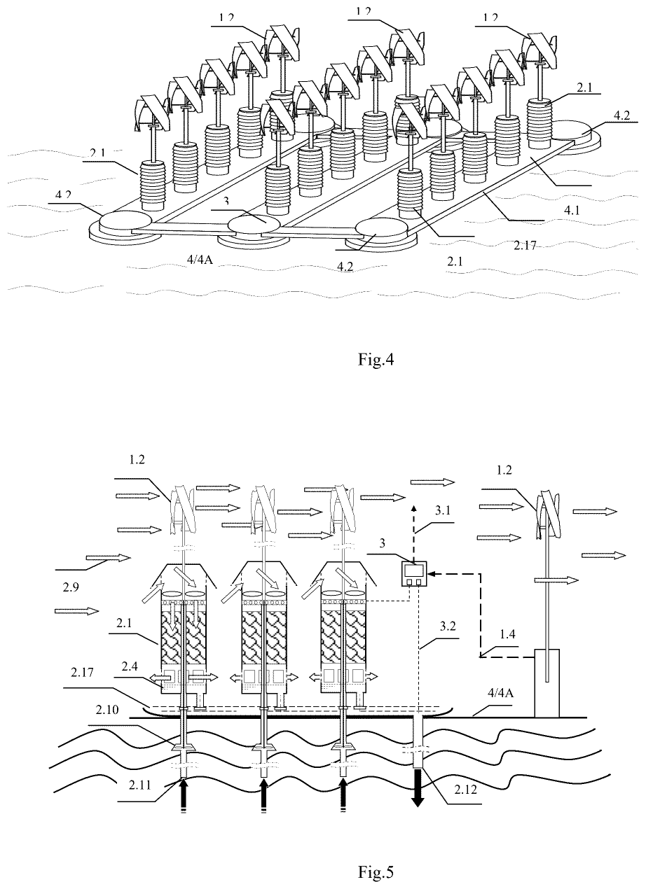

FIG. 4 shows another example of a net negative emission system specially used in the process of the present invention, characterized in that an array, which is composed of a plurality of vertical axis motor fans, and an array, which is composed of a plurality of natural wind absorbers, are installed on the ocean platform to form the special net negative emission ocean platform. A louvered ventilated shading cover 2.8′ is provided around the natural wind absorber.

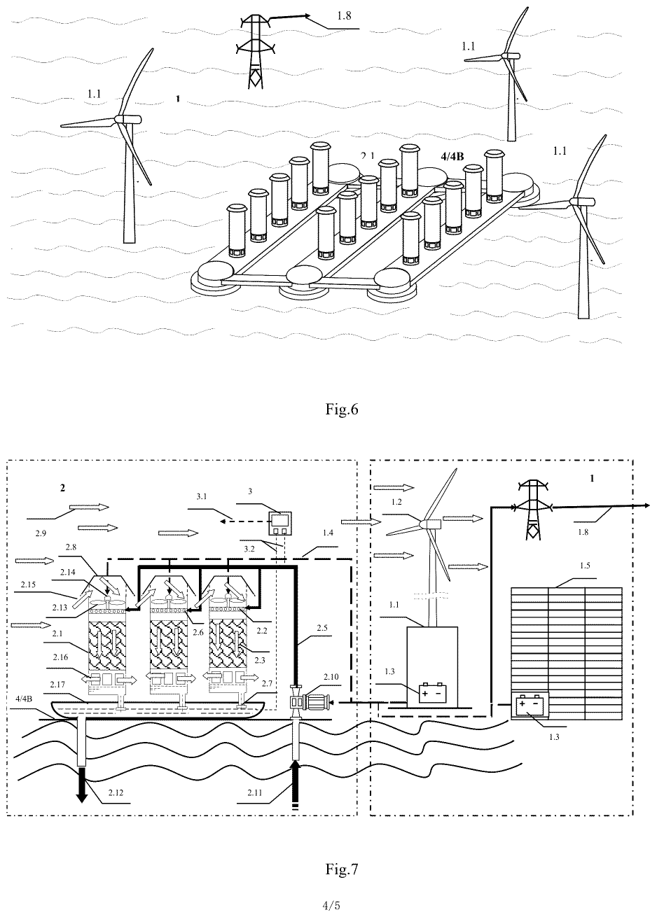

FIG. 5 shows another example of technical steps of the net negative emission system specially used in the process of the present invention, having the following characters. The vertical axis motor fan directly drives a fan to blow air axially. The air enters into the absorber axially. A shading cover is provided at the top of the absorber. The vertical axis motor fan also directly drives the seawater pump to pump seawater from a deep location. The seawater is introduced into the absorber, and flows through the packing layer to scrub the air to absorb CO₂. The special net negative emission system is equipped with a measuring and caculating system that can calculate CO₂e. This system is designed to run intermittently with wind force.

FIG. 6 shows an example of a net negative emission power plant system used in the process of the present invention, characterized in that the wind power plant and net negative emission ocean platform run cooperatively to generate electricity with net negative carbon emission and transmit it to the outside.

FIG. 7 shows an example of the technical steps of a net negative emission power plant system used in the process of the present invention, having the following characters. A wind turbine and/or a photovoltaic power station compose a carbon-free energy source. The generated electricity is used to drive the fan, which is located over the absorber, to blow air axially, causing air to flow through the packing layer along the absorber axis. A shading cover is provided over and around the absorbing column. The carbon-free energy power also drives the seawater pump to pump seawater from a deep location. The seaswater is introduced into the absorber, and flows through the packing layer to scrub the air to absorb CO₂. The special net negative emission system is equipped with a measuring and caculating system that can calculate CO₂e. The wind turbine and/or photovoltaic carbon free energy source are equipped with an energy storing device so that the net negative emission system can run uninterruptedly and generate electricity with net negative carbon emission to the outside.

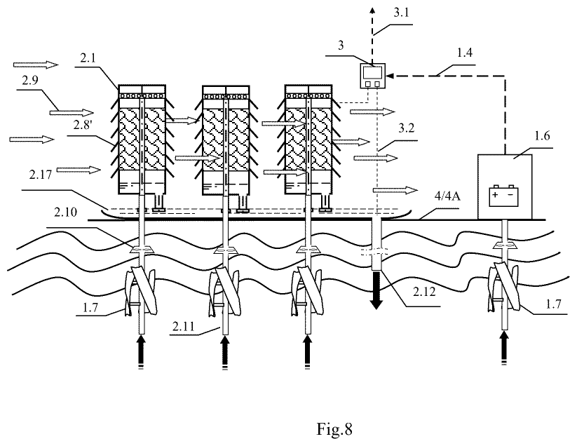

FIG. 8 shows an example of a net negative emission system of ocean waves and current energy specially used in the process of the present invention, having the following characters. An ocean current turbine 1.7 is installed on the floating ocean platform 4. The ocean waves and current energy is used to drive a seawater pump 2.10 to pump seawater from a deep location. The seawater is introduced into the absorber 2.1, and flows through the packing layer 2.3, and makes contact with the air, which blows through the absorber in the form of natural wind, to directly capture CO₂. A louvered ventilated shading cover 2.8′ is provided around the absorber, allowing natural wind to blow horizontally through the absorber and blocking out sunlight from entering into the absorber. An apparatus for using ocean current energy to generate power and storing energy 1.6 is provided to supply power for DAC CO₂e meter 3 and power system for moving floating platform 4.2. The floating ocean platform 4 can be moved to or anchored in a designated sea area as needed.

The scope of protection of the claims of the present invention is not limited to the above-mentioned examples.

1. A blue carbon process for direct air carbon capture and storage, comprising the steps of:
1) providing an absorber;
2) pumping seawater from an ocean below sea level to a height above sea level for the purpose of absorbing seawater, and introducing the absorbing seawater and air into the absorber;
3) allowing the absorbing seawater to absorb and capture the carbon dioxide from the air in the absorber to generate after-absorbing seawater; and
4) discharging the after-absorbing seawater out of the absorber and into the ocean below sea level through a water discharging pipe to realize ocean carbon storage;
wherein, the absorber comprises a shading cover for blocking out sunlight, so that the contact between the absorbing seawater and the air is performed under shading condition, to prevent or reduce growth of marine organisms inside the absorber.

2. The process of claim 1, wherein in the absorber, the absorbing seawater flows from top to bottom due to gravity, and the air flows from top to bottom, or flows from bottom to top, or flows laterally to make contact with the absorbing seawater.

3. The process of claim 1, wherein the process further comprises a step of providing a blowing device for introducing the air into the absorber.

4. The process of claim 1, wherein the process further comprises the steps of:
measuring the amount of carbon dioxide, which is absorbed and captured by the absorbing seawater from the air and is then converted to bicarbonate ions and discharged into the ocean below sea level with the absorbing seawater, to generate measurement data; and
transmitting the measurement data in real-time or periodically to a carbon accounting system.

5. The process of claim 1, wherein the absorber further includes packings for increasing the contact area between the absorbing seawater and the air.

6. The process of claim 1, wherein the absorbing seawater is pumped from the ocean below sea level to a height no more than 0.5 m, or 1 m, or 3 m, or 5 m, or 10 m, or 15 m, or 20 m, or 30 m, or 50 m above sea level to obtain potential energy, and the height is defined by the distance between an outlet of the absorbing seawater in the absorber and the sea level where the absorbing seawater is drawn.

7. The process of claim 1, wherein the process further comprises a step of providing a carbon-free energy apparatus for providing energy.

8. The process of claim 1, wherein
in the step of pumping seawater from an ocean below sea level to a height above sea level, the seawater is pumped from a depth not less than 0.5 m, or 1 m, or 3 m, or 5 m, or 10 m, or 15 m, or 20 m, or 30 m, or 50 m, or 100 m, or 200 m, or 300 m, or 500 m, or 1000 m, or 2000 m below sea level.

9. A system for direct air carbon capture and storage, including:
a seawater pump and a water drawing pipe for pumping seawater from an ocean below sea level to a height above sea level for the purpose of absorbing seawater;
an absorber for introducing air and the absorbing seawater, so that the absorbing seawater absorbs the carbon dioxide in the air for the purpose of after-absorbing seawater;
a water discharging pipe for discharging the after-absorbing seawater into the ocean below sea level;
wherein, the absorber includes a shading cover for blocking out sunlight, so that the contact between the absorbing seawater and the air is performed under shading condition, to prevent or reduce the growth of marine organisms inside the absorber.

10. The system of claim 9, wherein the absorber is configured so that the absorbing seawater flows from top to bottom due to gravity, and the air flows from top to bottom, or flows from bottom to top, or flows laterally to make contact with the absorbing seawater.

11. The system of claim 9, wherein the system further includes a CO₂e measuring apparatus for measuring the amount of carbon dioxide, which is absorbed and captured by the absorbing seawater from the air and is then converted to bicarbonate ions and discharged into the ocean below sea level with the absorbing seawater, to generate measurement data and transmitting the measurement data in real-time or periodically to a carbon accounting system.

12. The system of claim 9, wherein the absorber further includes packings for increasing the contact area between the absorbing seawater and the air.

13. The system of claim 9, wherein the absorber include a water distributor, and the height of an outlet of the distributor is no more than 0.5 m, or 1 m, or 3 m, or 5 m, or 10 m, or 15 m, or 20 m, or 30 m, or 50 m relative to the sea level where the absorbing seawater is drawn.

14. The system of claim 9, wherein the system includes a plurality of absorbers, and the after-absorbing generated by the absorbers is collected and discharged into the ocean below sea level through the water discharging pipe.

15. The system of claim 9, wherein the system further includes an energy delivering apparatus for delivering the energy produced by a carbon-free energy apparatus to an apparatus out of the system.
